(19) United States
(12) Patent Application Publication
(10) Pub. No.: US 2026/0050471 A1
(43) Pub. Date: Feb. 19, 2026

(54) INFORMATION PROCESSING DEVICE AND INFORMATION PROCESSING METHOD

(71) Applicant: Panasonic Automotive Systems Co., Ltd., Kanagawa (JP)

(72) Inventors: Akihito TAKEUCHI, Osaka (JP); Takumaru NAGAI, Osaka (JP); Kaoru YOKOTA, Hyogo (JP); Tomohisa SEZAKI, Kanagawa (JP); Tomoyuki HAGA, Nara (JP)

(73) Assignee: Panasonic Automotive Systems Co., Ltd., Kanagawa (JP)

(21) Appl. No.: 19/249,600

(22) Filed: Jun. 25, 2025

(30) Foreign Application Priority Data
Jul. 1, 2024 (JP) 2024-106270

(51) Int. Cl. G06F 9/48; G06F 9/455

(52) U.S. Cl. CPC G06F 9/4887; G06F 9/45558; G06F 2009/45595

(57) ABSTRACT

An information processing device includes a plurality of virtual machines (VMs) each of which includes a communication controller. The communication controller includes: a storage that stores a routing table; a determination processor that determines priorities of a plurality of update-target routing tables; a routing table generator that generates an update request message for one or more VMs that include the plurality of update-target routing tables; and a communicator that transmits the update request message to the one or more VMs. The routing table generator and the communicator generate and transmit the update request message to update a second update-target routing table after a first update-target routing table is updated. The second update-target routing table has a priority lower than a priority of the first update-target routing table.

### CROSS REFERENCE TO RELATED APPLICATION

The present application is based on and claims priority of Japanese Patent Application No. 2024-106270 filed on Jul. 1, 2024.

### FIELD

The present disclosure relates to an information processing device and the like provided to a vehicle.

### BACKGROUND

Conventionally, an electronic control device for vehicles provided to a vehicle has been proposed as an example of an information processing device (see, for example, Patent Literature (PTL) 1). The electronic control device for vehicles is any one of a plurality of electronic control units (ECUs) or a gateway connected to an in-vehicle network. For example, when an application program in an ECU (hereinafter, also referred to as an application) uses a service, the application requests the service from another ECU. The other ECU then responds to the ECU that requested the service. When a new service is added, the communication path between the ECU that uses the service and the ECU that provides the service is reflected in the routing table in the gateway so that the new service is executed.

### CITATION LIST

### Patent Literature

PTL 1: Japanese Patent No. 7043736

### SUMMARY

However, the electronic control device for vehicles according to PTL 1 can be improved upon.

In view of this, the present disclosure provides an information processing device and the like capable of improving upon the above related art.

An information processing device according to one aspect of the present disclosure is an information processing device provided to a vehicle. The information processing device includes: a plurality of virtual machines each of which includes a communication controller. The communication controller includes: a storage that stores a routing table for controlling a communication path between a plurality of application programs executed by the plurality of virtual machines; a determination processor that determines priorities of a plurality of update-target routing tables among a plurality of routing tables included in the plurality of virtual machines, each of the plurality of routing tables being the routing table; a routing table generator that generates an update request message for requesting one or more virtual machines including the plurality of update-target routing tables to update the plurality of update-target routing tables, the one or more virtual machines being included in the plurality of virtual machines; and a communicator that transmits the update request message to the one or more virtual machines, and the routing table generator generates the update request message and the communicator transmits the update request message to update a second update-target routing table after a first update-target routing table is updated among the plurality of update-target routing tables, the second update-target routing table having a priority lower than a priority of the first update-target routing table.

General and specific aspects disclosed above may be implemented using a system, a method, an integrated circuit, a computer program, a computer-readable recording medium such as a CD-ROM, or any combination of systems, methods, integrated circuits, computer programs, or recording media. The recording medium may be a non-transitory recording medium.

The information processing device according to the present disclosure is capable of improving upon the above related art.

Additional benefits and advantages according to one aspect of the present disclosure will become apparent from the description and drawings. The benefits and/or advantages may be obtained by various embodiments and features of the description and drawings, which need not all be provided.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a conceptual diagram illustrating an overview of an in-vehicle system.

FIG. 2 is a block diagram illustrating an overview of the in-vehicle system.

FIG. 3 illustrates an example of a configuration of an information processing device according to an embodiment.

FIG. 4 is a block diagram illustrating an example of a configuration of a communication controller according to the embodiment.

FIG. 5 illustrates an example of a manifest according to the embodiment.

FIG. 6 illustrates an example of a routing table according to the embodiment.

FIG. 7 illustrates an example of a priority list according to the embodiment.

FIG. 8 illustrates an example of an application location list according to the embodiment.

FIG. 9 is a flowchart of an example of processing operations performed by the information processing device according to the embodiment.

FIG. 10 is a flowchart of another example of processing operations performed by the information processing device according to the embodiment.

FIG. 11 illustrates an example of configurations of two information processing devices according to Variation 1 of the embodiment.

FIG. 12 illustrates an example of a manifest according to Variation 1 of the embodiment.

FIG. 13 illustrates an example of a global location list included in a global communication controller according to Variation 1 of the embodiment.

### DESCRIPTION OF EMBODIMENT

### (Underlying Knowledge Forming Basis of the Present Disclosure)

The inventors of the present application have found that the following problems arise in connection with the electronic control device for vehicles according to PTL 1 described in the “Background” section.

For example, in a software defined vehicle (SDV), battery electric vehicle (BEV), and the like, it is assumed that a plurality of virtual machines are provided in the virtualization platform of an ECU, and a plurality of applications on the virtual machines or the ECU work together to provide services. Here, it is assumed that a plurality of virtual machines are provided in the electronic control device for vehicles according to PTL 1, and a new application is installed on the electronic control device for vehicles. In other words, a new service is added to the electronic control device for vehicles. In such a case, in the electronic control device for vehicles according to PTL 1, a plurality of routing tables may be updated at the same time as the new application work (i.e., communicate) with the other existing applications. When many routing tables are updated at the same time, the processing load temporarily increases. In addition, the frequency with which a new application is installed or an installed application is updated after a vehicle is released to the market is not infrequent. Therefore, the processing load may temporarily increase each time such an installation of a new application or an update of an installed application is performed, i.e., frequently.

In order to solve such a problem, an information processing device according to a first aspect of the present disclosure is an information processing device provided to a vehicle. The information processing device includes: a plurality of virtual machines each of which includes a communication controller. The communication controller includes: a storage that stores a routing table for controlling a communication path between a plurality of application programs executed by the plurality of virtual machines; a determination processor that determines priorities of a plurality of update-target routing tables among a plurality of routing tables included in the plurality of virtual machines, each of the plurality of routing tables being the routing table; a routing table generator that generates an update request message for requesting one or more virtual machines including the plurality of update-target routing tables to update the plurality of update-target routing tables, the one or more virtual machines being included in the plurality of virtual machines; and a communicator that transmits the update request message to the one or more virtual machines, and the routing table generator generates the update request message and the communicator transmits the update request message to update a second update-target routing table after a first update-target routing table is updated among the plurality of update-target routing tables, the second update-target routing table having a priority lower than a priority of the first update-target routing table. The information processing device is, for example, an ECU.

With this, among a plurality of update-target routing tables, the second update-target routing table having a lower priority is updated after the first update-target routing table having a higher priority is updated. This prevents a plurality of update-target routing tables from being updated at once or at the same time. As a result, it is possible to prevent the processing load from temporarily increasing due to an update of the plurality of update-target routing tables. Moreover, it is possible to promptly update the first update-target routing table having a higher priority. Accordingly, it is possible to prevent the processing load from temporarily increasing as described above, while minimizing the possibility of inconvenience that occurs in communications between a plurality of application programs in the information processing device. In other words, the electronic control device for vehicles according to PTL 1 has such a problem that the processing load may temporarily increase, whereas the information processing device according to the first aspect of the present disclosure is capable of preventing the processing load from temporarily increasing.

Moreover, in the information processing device according to a second aspect, it may be that the communication controller further includes a routing table updater that, when the update request message transmitted from the communicator is received, updates at least one of the first update-target routing table or the second update-target routing table according to the update request message, the first update-target routing table and the second update-target routing table being stored in the storage included in the communication controller. The second aspect may depend from the first aspect.

With this, when an update request message is received, it is possible to appropriately update the update-target routing table according to the update request message.

Moreover, in the information processing device according to a third aspect, it may be that the routing table updater updates the at least one of the first update-target routing table or the second update-target routing table after authenticating the update request message and confirming a validity of the update request message. The third aspect may depend from the second aspect.

This prevents the routing table from being updated according to an invalid update request message, thereby improving the security performance.

Moreover, in the information processing device according to a fourth aspect, it may be that the determination processor further determines whether or not a processing load of the information processing device is greater than or equal to a threshold value, and when the processing load is greater than or equal to the threshold value, the determination processor determines the priorities of the plurality of update-target routing tables. The fourth aspect may depend from any one of the first aspect to the third aspect.

Accordingly, in a situation where the processing load of the information processing device is high, it is possible to prevent the processing load from further increasing when a plurality of update-target routing tables are updated at the same time. Moreover, when the processing load is less than the threshold value, the priorities are not determined. Hence, for example, a plurality of update-target routing tables can be updated at the same time. Therefore, it is possible to promptly control communications between a plurality of application programs.

Moreover, in the information processing device according to a fifth aspect, it may be that the determination processor further (a) obtains the processing load from a virtualization platform included in the information processing device, or (b) estimates the processing load based on a driving state of the vehicle. The fifth aspect may depend from the fourth aspect.

With this, an accurate processing load can be obtained from the virtualization platform. Alternatively, it is possible to estimate that the processing load is high when the vehicle is in an automatic operation, and to estimate that the processing load is low when the vehicle is in a parked state. As a result, even when it is not possible to obtain an accurate processing load, an appropriate processing load can be estimated.

Moreover, in the information processing device according to a sixth aspect, it may be that the determination processor further: identifies a plurality of second application programs when a first application program is changed on the information processing device, the plurality of second application programs being indicated by a manifest of the first application program and permitted to communicate with the first application program; and determines, as the priorities of the plurality of update-target routing tables, priorities of a plurality of routing tables corresponding to the second application programs among the plurality of routing tables included in the plurality of virtual machines, and when the first application program is changed on the information processing device is (a) when a new application program is installed on the information processing device as the first application program, or (b) when an existing application program included in the information processing device is updated as the first application program. The sixth aspect may depend from any one of the first aspect to the fifth aspect. The first application program is also referred to as a new application and the second application program is also referred to as a communication-permitted application.

With this, when the first application program is installed on the information processing device or when the first application program is updated after being installed, the plurality of routing tables required for communication of the first application program are treated as a plurality of update-target routing tables, according to the manifest of the first application program after being installed or updated. The priorities of the plurality of update-target routing tables are then determined. As a result, the required update-target routing tables can be selected appropriately, and the priorities of the update-target routing tables can be determined.

Moreover, in the information processing device according to a seventh aspect, it may be that (a) when the first update-target routing table is stored in the storage included in the communication controller in which the routing table updater is included, the routing table updater updates the first update-target routing table at a timing at which the update request message transmitted from the communicator is received, and (b) when the second update-target routing table is stored in the storage included in the communication controller in which the routing table updater is included, the routing table updater updates the second update-target routing table at a predetermined timing. The seventh aspect may depend from the second aspect or any one of the third aspect to the sixth aspect that depends from the second aspect.

This allows the first update-target routing table having a higher priority to be updated promptly. On the other hand, the second update-target routing table having a lower priority can be updated at a predetermined timing that is after the first update-target routing table is updated.

Moreover, in the information processing device according to an eighth aspect, it may be that the predetermined timing is (a) a timing at which a processing load of the information processing device becomes less than a threshold value, (b) a timing at which an ignition switch of the vehicle is switched from off to on, or (c) a timing at which a predetermined operation performed by a user is received. The eighth aspect may depend from the seventh aspect.

This allows the second update-target routing table having a lower priority to be updated at an appropriate timing.

Moreover, the information processing device according to a ninth aspect may further include: a global communication controller corresponding to the plurality of virtual machines. When a third application program that is one of the plurality of second application programs is not included in the information processing device, the global communication controller identifies an other information processing device that includes the third application program and is different from the information processing device, and transmits the update request message to the other information processing device. The ninth aspect may depend from the sixth aspect or from the seventh aspect or the eighth aspect that depends from the sixth aspect.

For example, the communication controller attempts to transmit an update request message to a virtual machine that includes a third application program and the update-target routing table corresponding to the third application program. However, the communication controller may not be able to transmit that update request message because where the virtual machine is located is unknown. However, in the ninth aspect, the global communication controller identifies another information processing device as the location of the virtual machine, so that the update request message can be appropriately transmitted. As a result, the routing tables can be updated between a plurality of information processing devices. In other words, the communication controller of each of the plurality of virtual machines included in the information processing device is capable of appropriately transmitting the update request message even if the locations of the virtual machines or containers, etc., included in the other information processing devices are unknown. As a result, each communication controller does not need to hold a list for the locations, leading to a reduction in the amount of data held in the communication controller.

Moreover, in the information processing device according to a tenth aspect, it may be that the global communication controller transmits the update request message to the communication controller of a virtual machine included in the plurality of virtual machines and including a third application program corresponding to the update request message, when receiving the update request message from a global communication controller of the other information processing device. The tenth aspect may depend from the ninth aspect.

This also allows the update-target routing table to be updated according to an update request message when the update request message is received from another information processing device.

Moreover, in the information processing device according to an eleventh aspect, it may be that the storage further stores a plurality of priority lists, the determination processor selects a priority list corresponding to a state of the vehicle from among the plurality of priority lists, and determines the priorities of the plurality of update-target routing tables by using the priority list selected, and each of the plurality of priority lists indicates the priorities of the plurality of routing tables included in the plurality of virtual machines. The eleventh aspect may depend from any one of the first aspect to the tenth aspect.

This allows the priorities of the plurality of update-target routing tables to be determined appropriately according to the state of the vehicle.

Moreover, in the information processing device according to a twelfth aspect, it may be that when the update request message transmitted from the communicator is received, and in a case where a message indicating that an application program has changed on the information processing device has been received during a predetermined period before the update request message is received, the routing table updater updates the at least one of the first update-target routing table or the second update-target routing table. The twelfth aspect may depend from the second aspect or any one of the third aspect to the eleventh aspect that depends from the second aspect.

With this, the message indicating that the application program has been changed on the information processing device is treated as an advance notice message. The advance notice message is a message that informs in advance that an update request message will be transmitted. When an update request message is received during a predetermined period after the advance notice message is received, the update-target routing table is updated according to the update request message. Accordingly, it is possible to prevent the case where, even though the application program has not been changed on the information processing device, an invalid update request message is received and the update-target routing table is updated according to the invalid update request message.

Moreover, an information processing method according to the first aspect of the present disclosure is an information processing method performed by an information processing device that is provided to a vehicle and includes a plurality of virtual machines. The information processing method includes: determining priorities of a plurality of update-target routing tables that are included in a plurality of routing tables included in the plurality of virtual machines, the plurality of routing tables each being a routing table for controlling a communication path between a plurality of application programs executed by the plurality of virtual machines; generating an update request message for requesting one or more virtual machines including the plurality of update-target routing tables to update the plurality of update-target routing tables, the one or more virtual machines being included in the plurality of virtual machines; and transmitting the update request message to the one or more virtual machines, wherein, in the generating and the transmitting of the update request message, the update request message is generated and transmitted to update a second update-target routing table after a first update-target routing table is updated among the plurality of update-target routing tables, the second update-target routing table having a priority lower than a priority of the first update-target routing table.

This produces the same operations and effects as those of the information processing device according to the first aspect.

Hereinafter, an embodiment will be specifically described with reference to the drawings.

The following embodiment describes a general or specific example. The numerical values, shapes, materials, structural elements, the arrangement and connection of the structural elements, steps, order of the steps, etc., shown in the following embodiment are mere examples, and therefore do not limit the present disclosure. Among the structural elements in the following embodiment, those not recited in any of the independent claims which indicate the highest concept are described as optional structural elements. Note that the figures are schematic illustrations and are not necessarily precise depictions. In the figures, elements that are essentially the same share like reference signs.

### EMBODIMENT

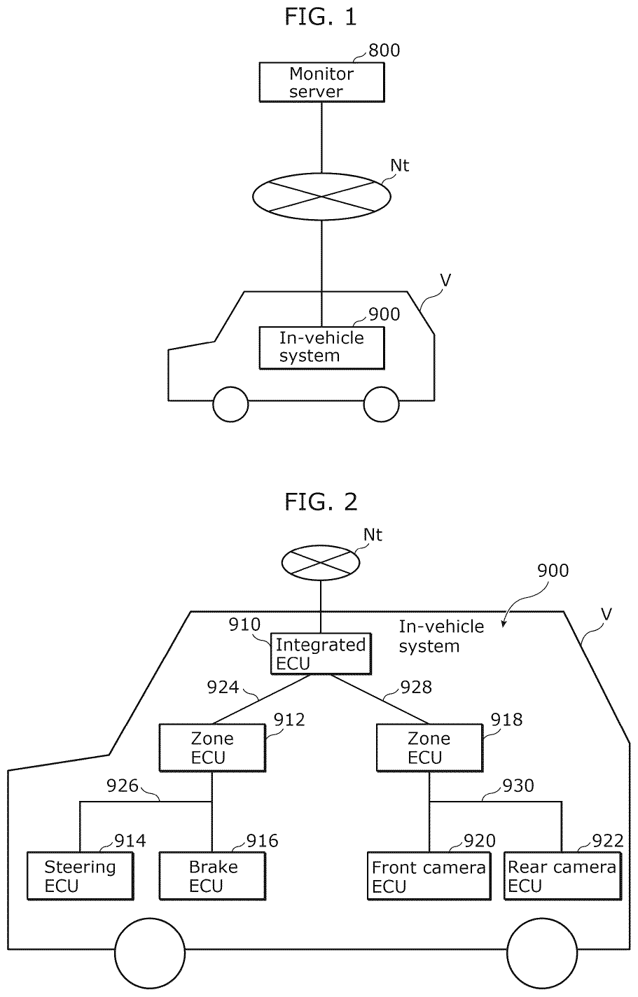

First, an overview of an in-vehicle system will be described with reference to FIG. 1 and FIG. 2. The in-vehicle system is an example of a system that includes an information processing device according to the present embodiment. FIG. 1 is a conceptual diagram illustrating an overview of an in-vehicle system. FIG. 2 is a block diagram illustrating an overview of the in-vehicle system.

As illustrated in FIG. 1, in-vehicle system 900 is applied to an automatic driving system provided to vehicle V, such as an automobile, for controlling driving operations such as acceleration and deceleration, steering, and braking of vehicle V to be performed automatically by an advanced driver assistance system (ADAS).

In-vehicle system 900 is capable of communicating with monitor server 800 via, for example, external network Nt, such as the Internet. In-vehicle system 900 monitors the occurrence of security anomalies in in-vehicle system 900, and notifies monitor server 800 of the monitoring results via external network Nt.

Monitor server 800 is provided, for example, in a security monitoring center. Monitor server 800 receives notifications from in-vehicle system 900, identifies the occurrence of security anomalies in each vehicle V, and provides advice on how to respond to such security anomalies.

In the example in FIG. 1, in-vehicle system 900 communicates with monitor server 800, but does not have to communicate with monitor server 800.

As illustrated in FIG. 2, in-vehicle system 900 includes integrated ECU 910, zone ECU 912, steering ECU 914, brake ECU 916, zone ECU 918, front camera ECU 920, and rear camera ECU 922.

Integrated ECU 910 is communicatively connected to zone ECU 912 via controller area network (CAN) 924. Zone ECU 912, steering ECU 914, and brake ECU 916 are communicatively connected with each other via CAN 926.

Integrated ECU 910 is also communicatively connected to zone ECU 918 via Ethernet (registered trademark) 928. Zone ECU 918, front camera ECU 920, and rear camera ECU 922 are communicatively connected with each other via Ethernet 930. Zone ECU 918 may be communicatively connected to other ECUS via CAN, not limited to Ethernet. Furthermore, integrated ECU 910 may be communicatively connected to, for example, monitor server 800 (see FIG. 1) via external network Nt.

Integrated ECU 910 performs, for example, (a) communication control for transmitting and receiving messages via external network Nt, CAN 924 and Ethernet 928, (b) vehicle control for instructing zone ECU 912 and zone ECU 918 to control vehicle V via CAN 924 and Ethernet 928, and (c) video output to an infotainment system and instrument panel. Integrated ECU 910 may monitor the occurrence of security anomalies (e.g., unauthorized accesses) in in-vehicle system 900 and notify monitor server 800 of the monitoring results. Integrated ECU 910 includes the functions of conventional individual ECUs. In other words, in integrated ECU 910, the functions of a plurality of conventional ECUs are integrated into one.

Zone ECU 912 mediates messages transmitted and received between integrated ECU 910, steering ECU 914, and brake ECU 916.

Steering ECU 914 controls steering by the steering wheel mounted on vehicle V.

Brake ECU 916 controls the driving of the brakes mounted on vehicle V.

In addition to steering ECU 914 and brake ECU 916, in-vehicle system 900 may use ECUs that control the engine and body of vehicle V to perform various controls such as running, turning, and stopping of vehicle V.

Zone ECU 918 mediates messages transmitted and received between integrated ECU 910 and front camera ECU 920 and rear camera ECU 922.

Front camera ECU 920 obtains forward images of vehicle V captured by a front camera mounted on the front of vehicle V. Rear camera ECU 922 obtains rearward images of vehicle V captured by a rear camera mounted on the rear of vehicle V.

The information processing device according to the present embodiment is, for example, integrated ECU 910, but may be any one of other ECUs.

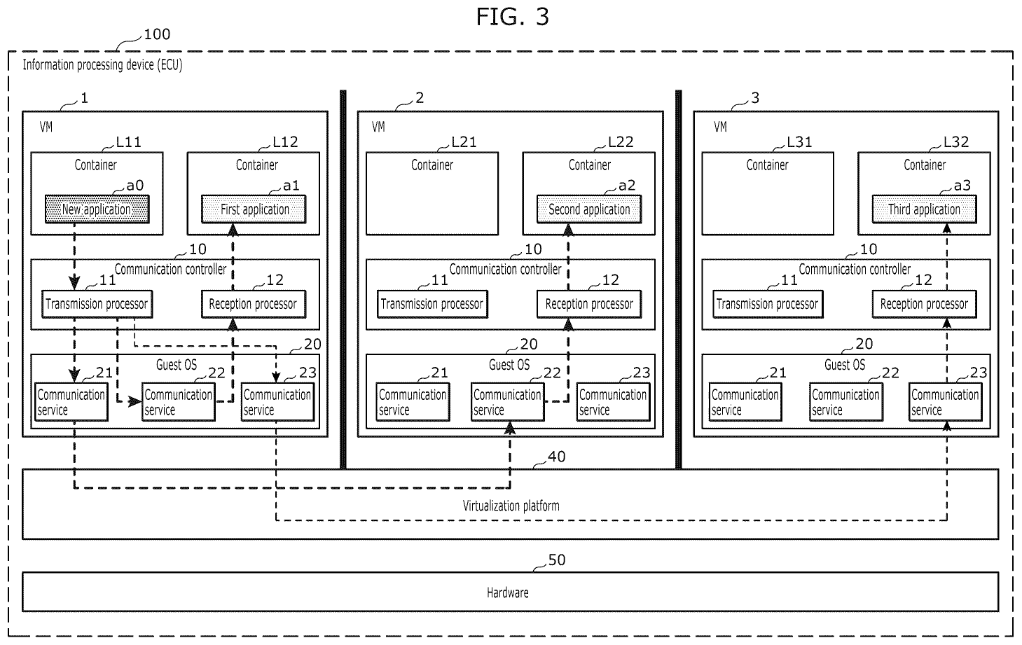

FIG. 3 illustrates an example of a configuration of an information processing device according to the present embodiment.

Information processing device 100 according to the present embodiment is a device provided to vehicle V and includes a plurality of virtual machines (VMs) each of which includes communication controller 10. The communication controller is also referred to as SCL, Security COMM Lib, or Security Communication Library. Specifically, as illustrated in FIG. 3, information processing device 100 includes VM 1 that includes communication controller 10, VM 2 that includes communication controller 10, and VM 3 that includes communication controller 10. Information processing device 100 further includes virtualization platform 40 and hardware 50.

VM 1 includes container L11, container L12, and guest operating system (OS) 20, along with communication controller 10. Container L11 and container L12 are also referred to as software areas where, for example, applications are stored. In the example in FIG. 3, newly installed application a0 (hereinafter, referred to as a new application) is stored in container L11, and first application a1 is stored in container L12. Communication controller 10 of VM 1 controls communications between container L11 and container L12 and between VM 1 and another VM. Specifically, each communication controller 10 includes transmission processor 11 and reception processor 12. Transmission processor 11 of VM 1 receives data such as messages from the application stored in container L11 or container L12, and transmits the data to the destination application. Reception processor 12 of VM 1 receives data such as messages from the source application and transmits the data to the application stored in container L11 or container L12.

In a similar manner to VM 1, VM 2 includes container L21, container L22, and guest OS 20, along with communication controller 10. Container L21 and container L22 are also referred to as software areas where, for example, applications are stored. In the example in FIG. 3, second application a2 is stored in container L22. Communication controller 10 of VM 2 controls communications between container L21 and container L22 and between VM 2 and another VM. Transmission processor 11 of VM 2 receives data such as messages from the application stored in container L21 or container L22 and transmits the data to the destination application. Reception processor 12 of VM 2 receives data such as messages from the source application and transmits the data to the application stored in container L21 or container L22.

In a similar manner to VM 1, VM 3 includes container L31, container L32, and guest OS 20, along with communication controller 10. Container L31 and container L32 are also referred to as software areas where, for example, applications are stored. In the example in FIG. 3, third application a3 is stored in container L32. Communication controller 10 of VM 3 controls communications between container L31 and container L32 and between VM 3 and another VM. Transmission processor 11 of VM 3 receives data such as messages from the application stored in container L31 or container L32 and transmits the data to the destination application. Reception processor 12 of VM 3 receives data such as messages from the source application and transmits the data to the application stored in container L31 or container L32.

Virtualization platform 40 is also called Hypervisor, and is a software program that runs on hardware 50 to achieve virtualization. In other words, VM 1, VM 2 and VM 3 are realized by virtualization platform 40.

Hardware 50 is, for example, configured as a system on a chip (SoC).

Here, new application a0 is stored in container L11 of VM 1 by being installed on VM 1 of information processing device 100. New application a0 is authorized to work with (i.e., communicate with) first application a1, second application a2, and third application a3. Such authorizations are indicated by the manifest of new application a0. Communication controller 10 of each of VM 1, VM 2, and VM 3 updates its own routing table based on the manifest. New application a0 communicates with first application a1, second application a2, and third application a3 according to those routing tables.

For example, when transmitting data to first application a1, new application a0 transmits the data to transmission processor 11 of VM 1. In VM 1, the data is then transmitted according to the routing table of VM 1 from transmission processor 11 to first application a1 in container L12 via communication service 22 in guest OS 20 and reception processor 12.

For example, when transmitting data to second application a2, new application a0 transmits the data to transmission processor 11 of VM 1. The data is then transmitted according to the routing tables of VM 1 and VM 2 from transmission processor 11 of VM 1 to second application a2 in container L22 of VM 2 via communication service 21 in guest OS 20 of VM 1, virtualization platform 40, communication service 22 in guest OS 20 of VM 2, and reception processor 12 of VM 2.

When transmitting data to third application a3, new application a0 transmits the data to transmission processor 11 of VM 1. The data is then transmitted according to the routing tables of VM 1 and VM 3 from transmission processor 11 of VM 1 to third application a3 in container L32 of VM 3 via communication service 23 in guest OS 20 of VM 1, virtualization platform 40, communication service 23 in guest OS 20 of VM 3, and reception processor 12 of VM 3.

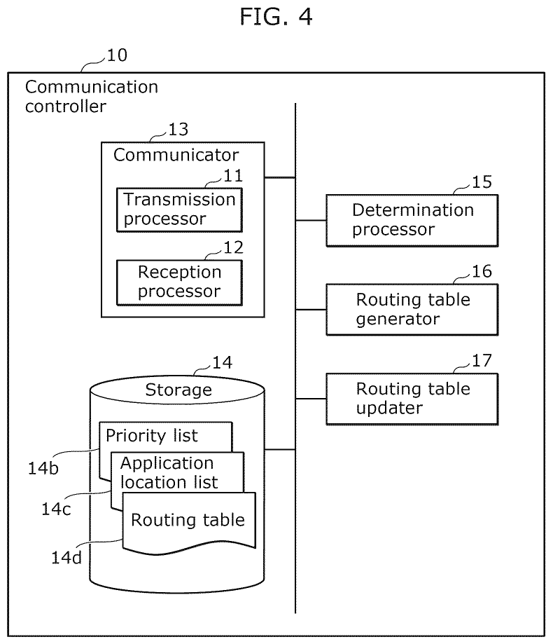

FIG. 4 is a block diagram illustrating an example of a configuration of communication controller 10 included in each of VM 1 to VM 3.

Communication controller 10 includes communicator 13, storage 14, determination processor 15, routing table generator 16, and routing table updater 17.

Communicator 13 includes transmission processor 11 and reception processor 12 illustrated in FIG. 3. Storage 14 is a recording medium in which priority list 14b, application location list 14c, and routing table 14d are stored. Routing table 14d is a table for controlling the communication paths between a plurality of applications executed by three VM 1 to VM 3. For example, when new application a0 is installed by guest OS 20 of VM 1, a plurality of routing tables 14d are updated to control the communication paths between new application a0 and a plurality of the other applications. In other words, among routing tables 14d included in VM 1 to VM 3, a plurality of routing tables 14d that are required to control the communication paths are updated as update-target routing tables. Priority list 14b and application location list 14c will be described later. Such storage 14 is, for example, a hard disk drive, random access memory (RAM), read only memory (ROM), or semiconductor memory. Storage 14 may be volatile or non-volatile.

Determination processor 15 determines the priorities of the plurality of update-target routing tables among routing tables 14d included in VM 1 to VM 3. At this time, determination processor 15 determines the priorities of the plurality of update-target routing tables by referring to application location list 14c and priority list 14b described above.

Routing table generator 16 generates update request messages to request one or more VMs that include the plurality of update-target routing tables to update the plurality of update-target routing tables. The update request messages each indicate, for example, the differences between the update-target routing table after the update and the update-target routing table before the update. Transmission processor 11 of communicator 13 transmits the update request messages to the one or more VMs.

Here, routing table generator 16 and transmission processor 11 according to the present embodiment generate and transmit an update request message to update a second update-target routing table after a first update-target routing table is updated among the plurality of update-target routing tables. The second update-target routing table has a priority lower than the priority of the first update-target routing table. The first update-target routing table and the second update-target routing table are routing tables 14d included in the plurality of update-target routing tables. The priority of the first update-target routing table determined by determination processor 15 is higher than the priority of the second update-target routing table determined by determination processor 15.

When routing table updater 17 receives an update request message from transmission processor 11 via reception processor 12, routing table updater 17 updates the update-target routing table stored in storage 14 according to the update request message. For example, routing table updater 17 of VM 2 receives the update request message from transmission processor 11 of VM 1 via reception processor 12 of VM 2. Routing table updater 17 of VM 2 then updates the update-target routing table stored in storage 14 of VM 2 according to the update request message. Routing table updater 17 may receive the update request message from transmission processor 11 included in the same VM in which routing table updater 17 is included. For example, routing table updater 17 of VM 1 receives the update request message from transmission processor 11 of VM 1 via reception processor 12 of VM 1. Routing table updater 17 of VM 1 then updates the update-target routing table stored in storage 14 of VM 1 according to the update request message. The update-target routing table is the first update-target routing table or the second update-target routing table described above.

In this way, when routing table updater 17 according to the present embodiment receives the update request message transmitted from communicator 13, routing table updater 17 updates, according to the update request message, at least one of the first update-target routing table or the second update-target routing table stored in storage 14 included in communication controller 10. With this, when an update request message is received, it is possible to appropriately update the update-target routing table according to the update request message.

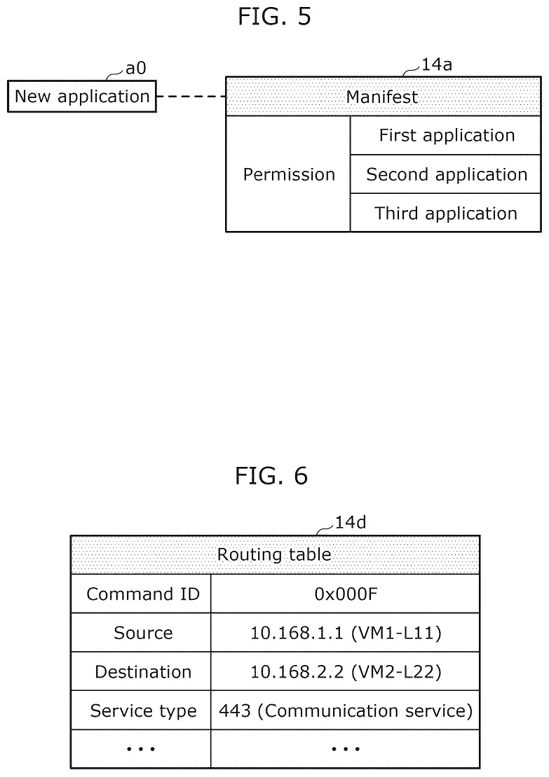

FIG. 5 illustrates an example of manifest 14a.

Manifest 14a is data associated with an application, and lists, as permissions, one or more other applications that are allowed to communicate with the application. In the example in FIG. 5, manifest 14a associated with new application a0 indicates first application a1, second application a2, and third application a3 as one or more other applications that are allowed to communicate with new application a0. For example, when new application a0 is installed on VM 1, guest OS 20 of VM 1 obtains manifest 14a of new application a0 together with new application a0, and stores manifest 14a in storage 14 of VM 1. Each application indicated by manifest 14a is also referred to as a communication-permitted application.

FIG. 6 illustrates an example of routing table 14d.

Routing table 14d indicates, for example, a command ID, a source, a destination, and a service type, as illustrated in FIG. 6. The command ID is the identification information of data, such as a message to be transmitted or received. The source indicates the application transmitting the data or the location of the application. The destination indicates the application receiving the data or the location of the application. The service type indicates the type of the communication service of guest OS 20 used to transmit and receive the data.

Specifically, routing table 14d illustrated in FIG. 6 indicates new application a0 in container L11 of VM 1 as the source and second application a2 in container L22 of VM 2 as the destination. Routing table 14d indicates “0x000F” as the command ID and “443” as the service type. Therefore, routing table 14d indicates that the data identified by the command ID “0x000F” is transmitted from new application a0 to second application a2 using the communication service of service type “443”. The communication service of the service type “443” may be, for example, communication service 21 of VM 1 and communication service 22 of VM 2. Routing table 14d as described is stored in storage 14 of each of VM 1 and VM 2. Communication controller 10 (more specifically, communicator 13) of each of VM 1 and VM 2 controls transmission of the data with command ID “0x000F” from new application a to second application a2 by referring to routing table 14d.

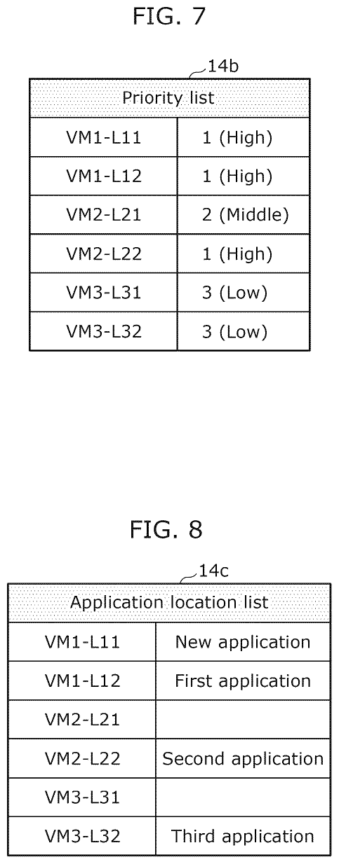

FIG. 7 illustrates an example of priority list 14b. VMx-Lyy in FIG. 7 means the container identified by code Lyy and included in the VM identified by code x. Code x is 1, 2, or 3, and code yy is 11, 12, 21, 22, 31, or 32.

Priority list 14b is a list for determining the priorities of a plurality of update-target routing tables. For example, priority list 14b indicates the priority of each container, as illustrated in FIG. 7. Specifically, priority list 14b indicates “1” as the priority for each of container L11 of VM 1 (i.e., VM 1-L11) and container L12 of VM 1 (i.e., VM 1-L12). Priority list 14b further indicates “1” as the priority of container L22 of VM 2 (i.e., VM 2-L22) and “3” as the priority of container L32 of VM 3 (i.e., VM 3-L32). The priority “1” is higher than the priority “2”, and the priority “2” is higher than the priority “3”. In other words, the priority “1” is a “high” priority, the priority “2” is a “medium” priority, and the priority “3” is a “low” priority.

It can be said that such priorities of the containers are also the priorities of routing tables 14d corresponding to the applications stored in the containers.

FIG. 8 illustrates an example of application location list 14c. In a similar manner to FIG. 7, VMx-Lyy in FIG. 8 means the container identified by code Lyy and included in the VM identified by code x.

Application location list 14c is a list that indicates an application located or stored in each container. Specifically, application location list 14c indicates that new application a0 is located in container L11 of VM 1 and first application a1 is located in container L12 of VM 1, as illustrated in FIG. 8. Application location list 14c further indicates that second application a2 is located in container L22 of VM 2 and third application a3 is located in container L32 of VM 3. In other words, application location list 14c indicates the location of each application in information processing device 100.

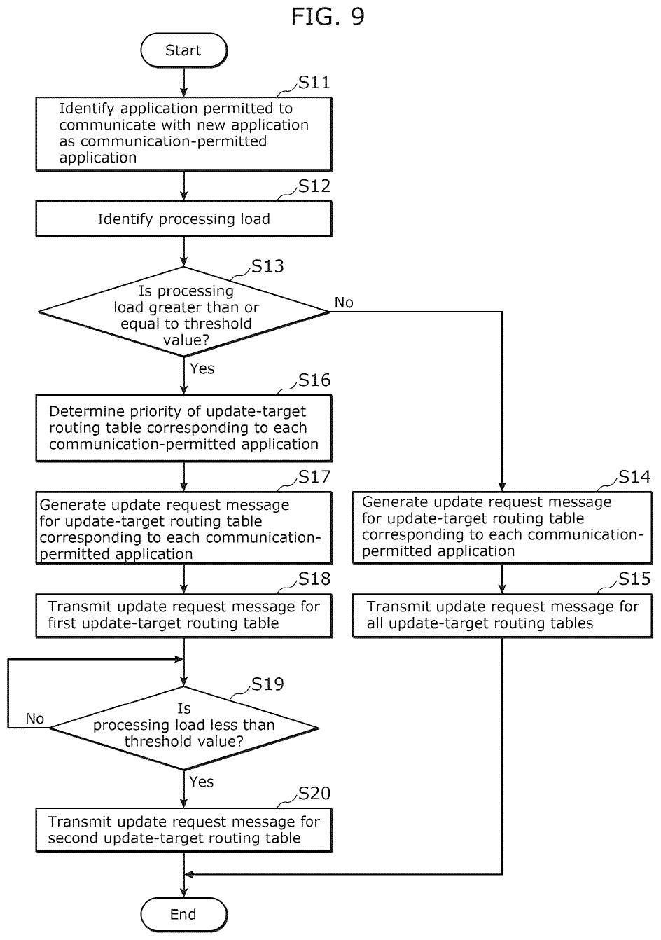

FIG. 9 is a flowchart of an example of processing operations performed by information processing device 100 according to the present embodiment. Specifically, the flowchart shows an example of processing operations performed when communication controller 10 of VM 1 transmits an update request message.

First, when new application a0 is installed on VM 1 of information processing device 100, determination processor 15 of VM 1 identifies one or more other applications that are permitted to communicate with new application a0 as communication-permitted applications (step S11). Specifically, determination processor 15 identifies first application a1, second application a2, and third application a3 as communication-permitted applications by referring to manifest 14a of new application a0 stored in storage 14.

Next, determination processor 15 identifies the processing load of information processing device 100 (step S12). For example, determination processor 15 identifies the processing load by obtaining the processing load from virtualization platform 40 included in information processing device 100. With this, an accurate processing load can be obtained from virtualization platform 40. Alternatively, determination processor 15 identifies the processing load by estimating the processing load based on the driving state of vehicle V. With this, it is possible to estimate that the processing load is high when vehicle V is in an automatic operation, and to estimate that the processing is low when vehicle V is in a parked state. As a result, even when an accurate processing load cannot be obtained, an appropriate processing load can be estimated.

Next, determination processor 15 determines whether or not the processing load of information processing device 100 is greater than or equal to a threshold value (step S13). Here, when determination processor 15 determines that the processing load is less than the threshold value (No in step S13), routing table generator 16 of VM 1 generates an update request message requesting an update of routing table 14d corresponding to each communication-permitted application (step S14). For example, first application a1, second application a2, and third application a3 are identified as communication-permitted applications. In this case, routing table generator 16 generates an update request message requesting an update of routing table 14d for each of first application a1, second application a2, and third application a3. These routing tables 14d are update-target routing tables. Transmission processor 11 in communicator 13 of VM 1 transmits the generated update request messages to communicators 13 of all VMs that include the update-target routing tables (step S15). For example, the update request message for routing table 14d corresponding to first application a1 is transmitted to communicator 13 (specifically, reception processor 12) of VM 1. The update request message for routing table 14d corresponding to second application a2 is transmitted to communicator 13 (specifically, reception processor 12) of VM 2. The update request message for routing table 14d corresponding to third application a3 is transmitted to communicator 13 (specifically, reception processor 12) of VM 3. In other words, the update request messages for all update-target routing tables are transmitted at the same time.

On the other hand, when determination processor 15 determines in step S13 that the processing load is greater than or equal to the threshold value (Yes in step S13), determination processor 15 determines the priority of routing table 14d corresponding to each communication-permitted application (step S16). These routing tables 14d are update-target routing tables. In other words, determination processor 15 determines the priorities of the plurality of update-target routing tables when the processing load is greater than or equal to the threshold value. At this time, determination processor 15 determines the priorities of the plurality of update-target routing tables by referring to application location list 14c and priority list 14b stored in storage 14.

For example, first application a1, second application a2, and third application a3 are identified as communication-permitted applications. In this case, determination processor 15 identifies the containers in which first application a1, second application a2, and third application a3 are located. For example, by referring to application location list 14c illustrated in FIG. 8, determination processor 15 identifies container L12 of VM 1 as the container in which first application a1 is located. Determination processor 15 further identifies container L22 of VM 2 as the container in which second application a2 is located and container L32 of VM 3 as the container in which third application a3 is located.

Next, determination processor 15 determines the priorities of those identified containers by using priority list 14b. For example, by referring to priority list 14b illustrated in FIG. 7, determination processor 15 determines the priority of “1 (high)” of container L12 of VM 1, the priority of “1 (high)” of container L22 of VM 2, and the priority of “3 (low)” of container L32 of VM 3. Here, it can be said that the priority of the container is the priority of routing table 14d corresponding to the application located in the container. Moreover, first application a1, second application a2, and third application a3 are respectively located in container L12 of VM 1, container L22 of VM 2, and container L32 of VM 3. Therefore, in step S16, determination processor 15 determines the priority of “1 (high)” as the priority of routing table 14d corresponding to first application a1, priority of “1 (high)” as the priority of routing table 14d corresponding to second application a2, and priority “3 (low)” as the priority of routing table 14d corresponding to third application a3.

Next, in a similar manner to step S14, routing table generator 16 generates update request messages requesting the update of routing table 14d corresponding to each communication-permitted application (step S17). For example, first application a1, second application a2, and third application a3 are identified as communication-permitted applications. In this case, routing table generator 16 generates an update request message requesting an update of routing table 14d corresponding to first application a1, an update request message requesting an update of routing table 14d corresponding to second application a2, and an update request message requesting an update of routing table 14d corresponding to third application a3. These routing tables 14d are update-target routing tables.

Transmission processor 11 in communicator 13 of VM 1 then transmits the generated update request messages (step S18). Specifically, transmission processor 11 transmits update request messages to communicator 13 of each of the VMs that include the first update-target routing tables, which are the update-target routing tables having a priority of “1 (high)” among a plurality of update-target routing tables. For example, routing tables 14d corresponding to first application a1 and second application a2 are the update-target routing tables, and a priority of “1 (high)” is determined as the priority of each of the update-target routing tables. In this case, routing tables 14d corresponding to first application a1 and second application a2 are the first update-target routing tables. Therefore, transmission processor 11 transmits the update request messages to communicators 13 of VM 1 and VM 2 that include the first update-target routing tables.

Next, determination processor 15 determines whether or not the processing load of information processing device 100 is less than a threshold value (step S19). Here, when determining that the processing load is greater than or equal to the threshold value (No in step S19), determination processor 15 repeats the process of step S19. On the other hand, when determination processor 15 determines that the processing load is less than the threshold value (Yes in step S19), transmission processor 11 in communicator 13 of VM 1 transmits update request messages to communicator 13 of each of the VMs that include the second update-target routing tables among the plurality of update-target routing tables (step S20). Here, each of the second update-target routing tables has a priority lower than the priority of the first update-target routing table. In other words, the second update-target routing tables are the update-target routing tables having a priority of “2 (medium)” or priority of “3 (low)”. For example, routing table 14d corresponding to third application a3 is the update-target routing table, and priority of “3 (low)” is determined as the priority of the update-target routing table. In this case, routing table 14d corresponding to third application a3 is the second update-target routing table. Therefore, transmission processor 11 transmits an update request message to communicator 13 of VM 3 that includes the second update-target routing table.

In this way, in the present embodiment, the update request message for the second update-target routing table having a lower priority is transmitted after the update request message for the first update-target routing table having a higher priority.

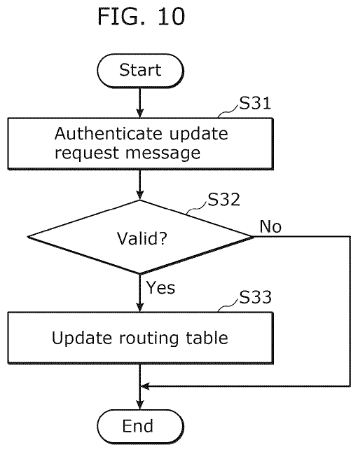

FIG. 10 is a flowchart of another example of processing operations performed by information processing device 100 according to the present embodiment. Specifically, the flowchart shows an example of processing operations performed when communication controller 10 of VM 2 updates routing table 14d according to an update request message from VM 1.

For example, when receiving the update request message transmitted from communicator 13 of VM 2, for example, reception processor 12 included in communicator 13 of VM 2 authenticates the update request message (step S31). For example, reception processor 12 performs authentication by digital signature. Reception processor 12 then determines through the authentication whether the update request message is valid (step S32). When reception processor 12 determines that the update request message is valid (Yes in step S32), routing table updater 17 of VM 2 updates routing table 14d corresponding to the update request message (step S33). This routing table 14d is the first update-target routing table or the second update-target routing table, and is stored in storage 14 of VM 2. In other words, routing table updater 17 of VM 2 reflects, in routing table 14d stored in storage 14 of VM 2, the differences indicated by the update request message. This updates routing table 14d to indicate, for example, the communication path from new application a0 to second application a2.

On the other hand, when reception processor 12 determines that the update request message is not valid (No in step S32), routing table updater 17 ends the process for the update request message without updating routing table 14d.

Therefore, in the present embodiment, the second update-target routing table having a lower priority is updated after the first update-target routing table having a higher priority is updated. In other words, among a plurality of update-target routing tables, the first update-target routing table having a higher priority is updated, and then the second update-target routing table having a lower priority is updated. This prevents a plurality of update-target routing tables from being updated at once or at the same time. As a result, it is possible to prevent the processing load from temporarily increasing due to updating of the plurality of update-target routing tables. Moreover, it is possible to promptly update the first update-target routing tables having high priorities. Accordingly, it is possible to prevent the processing load from temporarily increasing as described above, while minimizing the possibility of inconvenience that occurs in communications between a plurality of applications in information processing device 100.

Moreover, routing table updater 17 according to the present embodiment updates the at least one of the first update-target routing table or the second update-target routing table after authenticating the update request message and confirming a validity of the update request message. This prevents the routing table from being updated according to an invalid update request message, thereby improving the security performance.

In the present embodiment, when the processing load of information processing device 100 is greater than or equal to the threshold value, the priorities are determined and update request messages are transmitted according to the priorities. Accordingly, in a situation where the processing load of information processing device 100 is high, it is possible to prevent the processing load from further increasing when a plurality of update-target routing tables are updated at the same time. Moreover, when the processing load is less than the threshold value, the priorities are not determined. Hence, it is possible to update a plurality of update-target routing tables at the same time, for example, as in step S15 of FIG. 9, and to promptly control communications between a plurality of applications.

Moreover, as in the examples in FIG. 9 and FIG. 10, when the first update-target routing table is stored in storage 14 included in communication controller 10 in which routing table updater 17 is included, routing table updater 17 updates the first update-target routing table at the timing when the update request message transmitted from communicator 13 is received. In other words, when receiving the update request message, routing table updater 17 updates the first update-target routing table having a priority of “1 (high)” immediately after the authentication of the update request message. Communicator 13 described above may be communicator 13 included in the same VM in which routing table updater 17 is included, or may be communicator 13 included in another VM.

Routing table updater 17 updates the second update-target routing table at a predetermined timing, when the second update-target routing table is stored in storage 14 included in communication controller 10 in which routing table updater 17 is included. This allows the first update-target routing tables having priority of “1 (high)” to be updated promptly. On the other hand, the second update-target routing tables having a priority of “2 (medium)” or priority “3 (low)” can be updated at a predetermined timing that is after the first update-target routing tables are updated.

Specifically, the predetermined timing is the timing at which the processing load becomes less than the threshold value. More specifically, the predetermined timing is the timing at which routing table updater 17 receives an update request message after the processing load is determined to be less than the threshold value in step S19 of FIG. 9. This allows the second update-target routing tables having a priority of “2 (medium)” or “3 (low)” to be updated at an appropriate timing.

Here, the predetermined timing is not only the timing at which the processing load becomes less than the threshold value, but also any other timings after the timing at which the first update-target routing tables are updated. For example, the predetermined timing may be the timing at which the ignition switch of vehicle V is switched from off to on, or the timing at which a predetermined operation performed by the user is received. In other words, in step S19 of FIG. 9, determination processor 15 may determine whether the ignition switch of vehicle V has been switched from off to on, or whether a predetermined operation performed by the user has been received. This allows the second update-target routing tables having a lower priority to be updated at an appropriate timing.

In the present embodiment, when new application a0 is installed, determination processor 15 identifies a plurality of communication-permitted applications and determines the priorities of a plurality of update-target routing tables. However, determination processor 15 may identify a plurality of communication-permitted applications and determine the priorities of a plurality of update-target routing tables, not only when new application a0 is installed, but also when new application a0 is updated. Therefore, when new application a0 is changed on information processing device 100, determination processor 15 identifies a plurality of communication-permitted applications and determines the priorities of a plurality of update-target routing tables.

In other words, in the present embodiment, when new application a0 is changed on information processing device 100, determination processor 15 identifies a plurality of communication-permitted applications that are permitted to communicate with new application a0 and indicated by manifest 14a of new application a0. Determination processor 15 then determines the priorities of the plurality of routing tables 14d that are included in routing tables 14d included in VM 1, VM 2, and VM 3 and correspond to the plurality of communication-permitted applications, as the priorities of a plurality of update-target routing tables. When new application a0 is changed on information processing device 100 is (a) when a new application is installed on information processing device 100 as new application a0, or (b) when an existing application included in information processing device 100 is updated as new application a0. New application a0 is also referred to as a first application program, and the communication-permitted application is also referred to as a second application program. With this, when new application a0 is installed on information processing device 100 or when new application a0 after being installed is updated, according to manifest 14a of new application a0 after being installed or updated, a plurality of routing tables 14d required for communication with new application a0 are treated as a plurality of update-target routing tables. The priorities of the plurality of update-target routing tables are then determined. As a result, the required update-target routing tables can be selected appropriately, and the priorities of the update-target routing tables can be determined.

In the examples of FIG. 9 and FIG. 10, the timing at which the update request message for the first update-target routing table is transmitted is different from the timing at which the update request message for the second update-target routing table is transmitted. With this, the second update-target routing table is updated after the first update-target routing table is updated. However, the timing at which the update request message for the first update-target routing table and the timing at which the update request message for the second update-target routing table may be the same. In this case, when the transmitted update request message for the second update-target routing table is received by communicator 13, routing table updater 17, which is included in the same VM as communicator 13, may update the second update-target routing table at the predetermined timing described above. As described above, the predetermined timing may be the timing at which the processing load becomes less than the threshold value, the timing at which the ignition switch of vehicle V is switched from off to on, or the timing at which a predetermined operation performed by the user is received.

### (Variation 1)

In the embodiment described, an application in information processing device 100 works with the other applications in information processing device 100. In other words, in Variation 1, an application in information processing device 100 is capable of working with other applications in another information processing device 100. Information processing device 100 and the other information processing device 100 are each, for example, an ECU. In order to distinguish between the two, information processing device 100 is referred to as a first ECU and the other information processing device 100 is referred to as a second ECU.

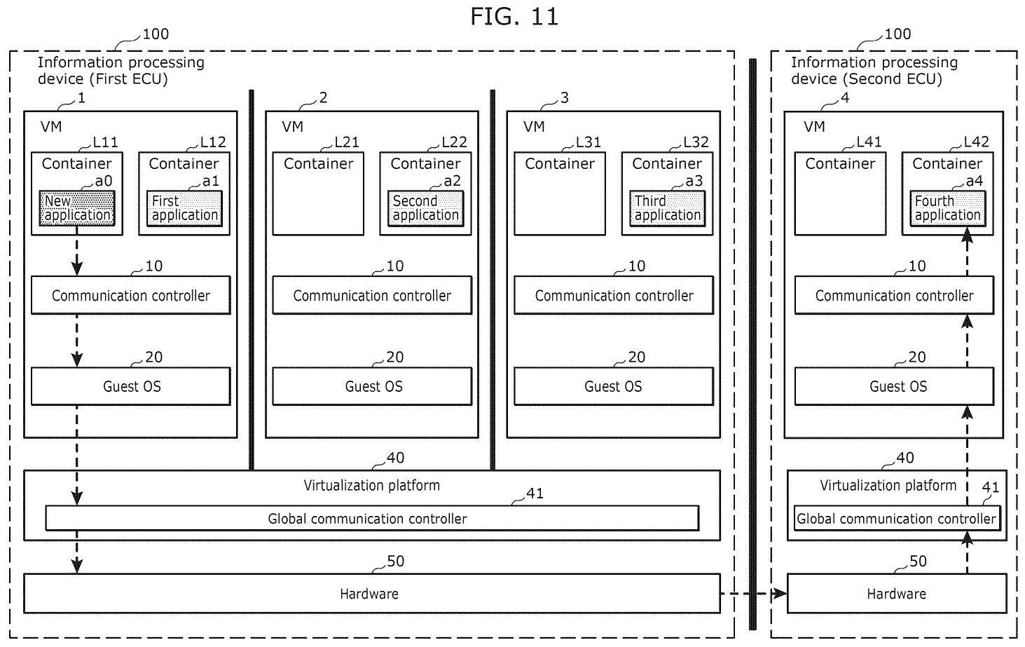

FIG. 11 illustrates an example of a configuration of two information processing devices 100 according to Variation 1.

One of two information processing devices 100 is the first ECU and the other is the second ECU. Each of two information processing devices 100 according to Variation 1 includes the same configuration as information processing device 100 illustrated in FIG. 3 according to the embodiment. In the example illustrated in FIG. 11, information processing device 100 serving as the second ECU includes VM 4 as a virtual machine that includes container L41 and container L42. Fourth application a4 is stored in container L42. In the example illustrated in FIG. 11, although only one VM (i.e. VM 4) is illustrated in the second ECU, a plurality of VMs may be included in the second ECU.

Virtualization platform 40 of each of two information processing devices 100 includes global communication controller 41. Global communication controller 41 is referred to as a global SCL, and corresponds to a plurality of VMs. In other words, global communication controller 41 of the first ECU corresponds to VM 1, VM 2, and VM 3 so as to control their communications. In a similar manner, global communication controller 41 of the second ECU corresponds to a plurality of VMs including VM 4 so as to control their communications.

Global communication controller 41 as described above communicates with another global communication controller 41. In other words, global communication controller 41 of the first ECU communicates with global communication controller 41 of the second ECU via hardware 50 of the first ECU and hardware 50 of the second ECU. Each global communication controller 41 is capable of detecting not only the locations of the applications included in information processing device 100 that includes global communication controller 41, but also the locations of the applications included in other information processing devices 100. For example, global communication controller 41 of the first ECU is capable of detecting the locations of new application a0, first application a1, second application a2, and third application a3, but also the location of fourth application a4. In a similar manner, global communication controller 41 of the second ECU is capable of detecting not only the location of fourth application a4, but also the locations of new application a0, first application a1, second application a2, and third application a3.

Accordingly, when new application a0, which is authorized to work with fourth application a4 of the second ECU, is installed on VM 1 of the first ECU, global communication controller 41 of the first ECU is capable of transmitting an update request message to VM 4 in response to a request from communication controller 10 of VM 1. In other words, global communication controller 41 of the first ECU is capable of transmitting an update request message to communication controller 10 of VM 4 via global communication controller 41 of the second ECU.

The details of information processing device 100 according to Variation 1 are as described below.

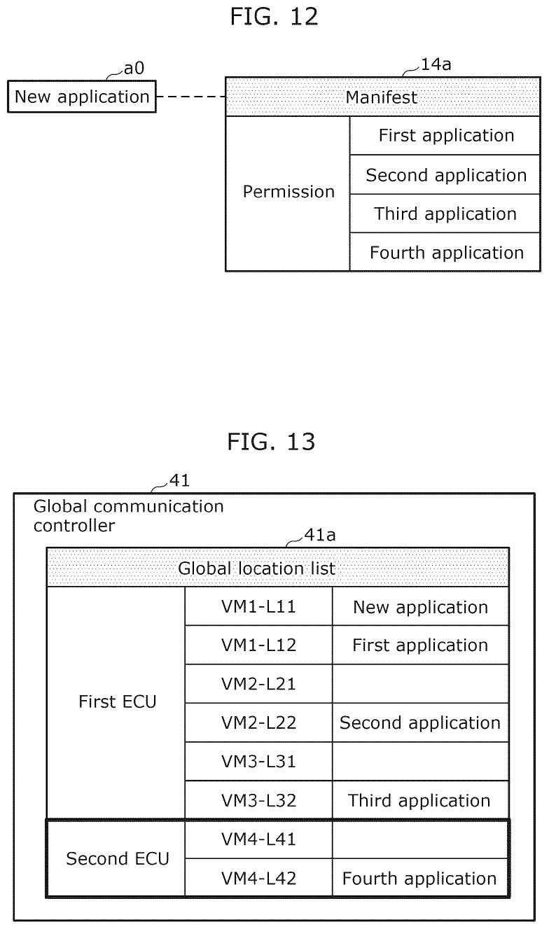

FIG. 12 illustrates an example of manifest 14a according to Variation 1.

As illustrated in FIG. 12, for example, manifest 14a of new application a0 indicates not only first application a1, second application a2, and third application a3, but also fourth application a4 as one or more applications that are allowed to communicate with new application a0. In other words, new application a0 is authorized to work with fourth application a4 in the second ECU.

FIG. 13 illustrates an example of global location list 41a included in global communication controller 41.

In a similar manner to application location list 14c, global location list 41a is a list that indicates an application located or stored in each container. Global location list 41a indicates not only the application in each container included in one information processing device 100 as in application location list 14c, but also the application in each container included in another information processor 100. In other words, global location list 41a is a list that indicates an application located or stored in each container included in a plurality of information processing devices 100. The plurality of information processing devices 100 are, for example, the first ECU and the second ECU. By referring to such global location list 41a, global communication controller 41 is capable of detecting the locations of not only the applications included in information processing device 100 that includes global communication controller 41, but also the applications included in other information processing devices 100.

Here, when new application a0 is installed on VM 1, determination processor 15 in communication controller 10 of VM 1 refers to manifest 14a illustrated in FIG. 12, and determines the priority of routing table 14d corresponding to each application (i.e., communication-permitted application) in manifest 14a. The priority of routing table 14d corresponding to each of first application a1, second application a2, and third application a3 is determined in the same manner as the embodiment described above. On the other hand, determination processor 15 is not capable of identifying the location (i.e., container) of fourth application a4 even by referring to application location list 14c stored in storage 14 of VM 1. Therefore, determination processor 15 is not capable of determining the priority of routing table 14d corresponding to fourth application a4.

In view of the above, determination processor 15 requests global communication controller 41 of the first ECU to perform the process related to updating routing table 14d corresponding to fourth application a4. When global communication controller 41 of the first ECU receives the request for the process from determination processor 15, global communication controller 41 of the first ECU identifies the container in which fourth application a4 is located by referring to global location list 41a in FIG. 13. Global communication controller 41 then determines the priority of the container. Global communication controller 41 then transmits an update request message for routing table 14d corresponding to fourth application a4 to global communication controller 41 of information processing device 100 (i.e., the second ECU) including the container at the timing corresponding to the determined priority.

When global communication controller 41 of the second ECU receives the update request message, global communication controller 41 of the second ECU identifies VM 4 that includes fourth application a4 by referring to global location list 41a included in global communication controller 41. Global communication controller 41 then transmits an update request message to communication controller 10 of VM 4. As a result, in a similar manner to the embodiment described above, routing table 14d corresponding to fourth application a4 is updated according to the update request message by communication controller 10 of VM 4.

As described above, in Variation 1, when fourth application a4, which is one of a plurality of communication-permitted applications, is not included in the first ECU, global communication controller 41 of the first ECU identifies the second ECU, which is another ECU different from the first ECU and includes fourth application a4, and transmits an update request message to the second ECU. Fourth application a4 is also referred to as a third application program. When the first ECU is referred to as information processing device 100, the second ECU is referred to as another information processing device 100. For example, it is assumed that communication controller 10 of VM 1 attempts to transmit an update request message to VM 4 that includes a third application program and an update-target routing table corresponding to the third application program. However, communication controller 10 of VM 1 is not capable of transmitting the update request message because the location of VM 4 is unknown. However, in Variation 1, since global communication controller 41 of the first ECU identifies the second ECU as the location of VM 4, the update request message can be appropriately transmitted. As a result, routing tables 14d between a plurality of ECUs can be updated. In other words, communication controller 10 of each of VM 1 to VM 3 included in the first ECU is capable of appropriately transmitting the update request message even when the locations of VM 4, container L41, and container L42, etc. included in the second ECU are unknown. As a result, each communication controller 10 does not need to hold application location list 14c for identifying the locations, leading to a reduction in the amount of data held in communication controller 10.

When receiving an update request message from global communication controller 41 of the first ECU, global communication controller 41 of the second ECU transmits the update request message to communication controller 10 of the VM that includes fourth application a4 corresponding to the update request message (i.e., VM 4) among a plurality of VMs including VM 4. When the second ECU is referred to as information processing device 100, the first ECU is also referred to as another information processing device 100. With this, when receiving an update request message from the first ECU, the second ECU is capable of updating the update-target routing table according to the update request message.

### (Variation 2)

In the embodiment and Variation 1 described above, one priority list 14b is stored in storage 14. On the other hand, in Variation 2, a plurality of priority lists 14b are stored in storage 14. Priority list 14b referred to by determination processor 15 is then dynamically switched.

In other words, determination processor 15 selects priority list 14b according to the state of vehicle V from among the plurality of priority lists 14b stored in storage 14. Determination processor 15 then determines the priorities of the plurality of update-target routing tables by using priority list 14b selected. Each of the plurality of priority lists 14b indicates the priorities of routing tables 14d included in the plurality of VMs. The plurality of priority lists 14b may include priority list 14b for automatic driving, priority list 14b for normal driving, and priority list 14b for stopped state. Determination processor 15 selects priority list 14b for automatic driving when vehicle V is in an automatic driving operation, selects priority list 14b for normal driving when vehicle V is in a normal driving operation, and selects priority list 14b for stopped state when vehicle V is in a stopped state. This allows the priorities of the plurality of update-target routing tables to be determined appropriately according to the state of vehicle V. The plurality of priority lists 14b stored in storage 13 are not limited to priority list 14b for automatic driving, priority list 14b for normal driving, and priority list 14b for stopped state. The plurality of priority lists 14b may include any priority lists 14b as long as priority lists 14b correspond to respective states or functions of vehicle V. The number of the plurality of priority lists 14b is not limited to three, but may be any number as long as the number is at least two.

In the embodiment, after authentication of the update request message, routing table 14d is updated according to the update request message. On the other hand, in Variation 2, routing table updater 17 updates routing table 14d according to the update request message based not only on the authentication of the update request message, but also on an advance notice of the update request message. For example, when new application a0 is installed on VM 1 of information processing device 100, communication controller 10 of VM 1 transmits an advance notice message to communication controller 10 of each of the VMs including communication-permitted applications corresponding to new application a0. The advance notice message is a message that indicates that an application has been changed on information processing device 100, and informs in advance that the change will cause an update request message to be transmitted. For example, routing table updater 17 in communication controller 10 of VM 2 receives the update request message from communication controller 10 of VM 1. At this time, routing table updater 17 of VM 2 updates the update-target routing table according to the update request message, when the validity of the update request message is confirmed by the authentication and an advance notice message has been received in advance. Routing table updater 17 may update the update-target routing table when the validity of the update request message is confirmed by the authentication and the update request message is received within, for example, 10 seconds after the receipt of the advance notice message.

In this way, when routing table updater 17 according to Variation 2 receives the update request message transmitted from communicator 13, and in a case where routing table updater 17 has received a message indicating that the application program has been changed on information processing device 100 during a predetermined period before the receipt of the update request message, routing table updater 17 updates at least one of the first update-target routing tables or the second update-target routing tables. The predetermined period is, for example, ten seconds. With this, the message indicating that the application has been changed on information processing device 100 is treated as an advance notice message. The advance notice message is a message that informs in advance that an update request message will be transmitted. When the update request message is received before a predetermined period passes after the receipt of the advance notice message, the update-target routing table is updated according to the update request message. Accordingly, it is possible to prevent the case where, even though the application has not been changed on information processing device 100, an invalid update request message is received and the update-target routing table is updated according to the invalid update request message.

The information processing device according to the present disclosure has been described based on the embodiment and variations. However, the present disclosure is not limited to the embodiment and the variations. Embodiments obtained by performing modifications on the embodiment or various variations conceived by a person skilled in the art and embodiments established by combining the embodiment and variations are also included in the present disclosure as long as they do not depart from the spirit of the present disclosure.

Each of the structural elements in the above-described embodiment and variations may be configured in the form of an exclusive circuit or hardware product, or may be realized by executing a software program suitable for the structural element. Each of the structural elements may be realized by means of a program executing unit, such as a central processing unit (CPU) or a processor, reading and executing the software program recorded on a recording medium such as a hard disk or a semiconductor memory. Here, the program that is software for realizing the device or system according to the embodiment causes a computer to execute each step in the flowcharts in FIG. 9 and FIG. 10.

The following cases are also included in the present disclosure.
(1) The device or system described above may specifically be a computer system including a microprocessor, a read only memory (ROM), a random access memory (RAM), a hard disk unit, a display unit, a keyboard, a mouse and the like. The RAM or the hard disk unit stores a computer program. The device or system achieves its function by the microprocessor operating according to the computer program. Here, a computer program is formed of combinations of instruction codes indicating commands to a computer to achieve a predetermined function.
(2) Part or all of the structural elements included in the device or system may be configured by a single system large scale integration (LSI). The system LSI is an ultra-multifunctional LSI manufactured by integrating a plurality of structural elements on a single chip, and specifically, is a computer system including a microprocessor, a ROM, a RAM and the like. A computer program is stored in the RAM. The system LSI achieves its function by the microprocessor operating according to the computer program.
(3) Part or all of the structural elements included in the device or system may be configured with an integrated circuit (IC) card removable from the device or system, or a single module. The IC card or the module is a computer system including a microprocessor, a ROM, a RAM, and the like. The IC card or the module may include the above-mentioned ultra-multifunctional LSI. The IC card or the module achieves its function by the microprocessor operating according to the computer program. The IC card or the module may be tamper resistant.
(4) The present disclosure may be implemented by the method described above. Moreover, the method may be a computer program implemented by a computer or a digital signal configured from the computer program.

Moreover, the present disclosure may be a computer program or a digital signal recorded on a computer-readable recording medium, such as a flexible disk, a hard disk, a compact disc (CD)-ROM, a DVD, a DVD-ROM, a DVD-RAM, a BD (Blu-ray (registered trademark) Disc), and a semiconductor memory. Moreover, it may be the digital signal recorded on these recording media.

Moreover, the present disclosure may transmit the computer program or digital signal via an electronic communication line, a wireless or wired communication line, a network represented by the Internet, a data broadcast, and the like.

Moreover, the program or the digital signal may be recorded on a recording medium and transferred, or the program or the digital signal may be transferred via the network or the like to be implemented by another independent computer system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-106270 filed on Jul. 1, 2024.

### INDUSTRIAL APPLICABILITY

An information processing device according to the present disclosure is capable of preventing a processing load from increasing temporarily, and is applicable to a device, system, or the like provided to a vehicle.

1. An information processing device provided to a vehicle, the information processing device comprising:
a memory that stores a program; and
a processor,
wherein, by executing the program, the processor operates as a plurality of virtual machines each of which includes a communication controller,
the communication controller includes:
a storage that stores a routing table for controlling a communication path between a plurality of application programs executed by the plurality of virtual machines;
a determination processor that determines priorities of a plurality of update-target routing tables among a plurality of routing tables included in the plurality of virtual machines, each of the plurality of routing tables being the routing table;
a routing table generator that generates an update request message for requesting one or more virtual machines including the plurality of update-target routing tables to update the plurality of update-target routing tables, the one or more virtual machines being included in the plurality of virtual machines; and
a communicator that transmits the update request message to the one or more virtual machines, and
the routing table generator generates the update request message and the communicator transmits the update request message to update a second update-target routing table after a first update-target routing table is updated among the plurality of update-target routing tables, the second update-target routing table having a priority lower than a priority of the first update-target routing table.

2. The information processing device according to claim 1,
wherein the communication controller further includes a routing table updater that, when the update request message transmitted from the communicator is received, updates at least one of the first update-target routing table or the second update-target routing table according to the update request message, the first update-target routing table and the second update-target routing table being stored in the storage included in the communication controller.

3. The information processing device according to claim 2,
wherein the routing table updater updates the at least one of the first update-target routing table or the second update-target routing table after authenticating the update request message and confirming a validity of the update request message.

4. The information processing device according to claim 1,
wherein the determination processor further determines whether or not a processing load of the information processing device is greater than or equal to a threshold value, and
when the processing load is greater than or equal to the threshold value, the determination processor determines the priorities of the plurality of update-target routing tables.

5. The information processing device according to claim 4,
wherein the determination processor further:
(a) obtains the processing load from a virtualization platform included in the information processing device, or
(b) estimates the processing load based on a driving state of the vehicle.

6. The information processing device according to claim 1,
wherein the determination processor further:
identifies a plurality of second application programs when a first application program is changed on the information processing device, the plurality of second application programs being indicated by a manifest of the first application program and permitted to communicate with the first application program; and
determines, as the priorities of the plurality of update-target routing tables, priorities of a plurality of routing tables corresponding to the plurality of second application programs among the plurality of routing tables included in the plurality of virtual machines, and
when the first application program is changed on the information processing device is:
(a) when a new application program is installed on the information processing device as the first application program; or
(b) when an existing application program included in the information processing device is updated as the first application program.

7. The information processing device according to claim 2,
wherein, (a) when the first update-target routing table is stored in the storage included in the communication controller in which the routing table updater is included, the routing table updater updates the first update-target routing table at a timing at which the update request message transmitted from the communicator is received, and
(b) when the second update-target routing table is stored in the storage included in the communication controller in which the routing table updater is included, the routing table updater updates the second update-target routing table at a predetermined timing.

8. The information processing device according to claim 7,
wherein the predetermined timing is (a) a timing at which a processing load of the information processing device becomes less than a threshold value, (b) a timing at which an ignition switch of the vehicle is switched from off to on, or (c) a timing at which a predetermined operation performed by a user is received.

9. The information processing device according to claim 6, further comprising:
a global communication controller corresponding to the plurality of virtual machines,
wherein, when a third application program that is one of the plurality of second application programs is not included in the information processing device, the global communication controller identifies an other information processing device that includes the third application program and is different from the information processing device, and transmits the update request message to the other information processing device.

10. The information processing device according to claim 9,
wherein the global communication controller transmits the update request message to the communication controller of a virtual machine included in the plurality of virtual machines and including a third application program corresponding to the update request message, when receiving the update request message from a global communication controller of the other information processing device.

11. The information processing device according to claim 1,
wherein the storage further stores a plurality of priority lists,
the determination processor selects a priority list corresponding to a state of the vehicle from among the plurality of priority lists, and determines the priorities of the plurality of update-target routing tables by using the priority list selected, and
each of the plurality of priority lists indicates the priorities of the plurality of routing tables included in the plurality of virtual machines.

12. The information processing device according to claim 2,
wherein, when the update request message transmitted from the communicator is received, and in a case where a message indicating that an application program has changed on the information processing device has been received during a predetermined period before the update request message is received, the routing table updater updates the at least one of the first update-target routing table or the second update-target routing table.

13. An information processing method performed by an information processing device that is provided to a vehicle and includes a plurality of virtual machines, the information processing method comprising:
determining priorities of a plurality of update-target routing tables that are included in a plurality of routing tables included in the plurality of virtual machines, the plurality of routing tables each being a routing table for controlling a communication path between a plurality of application programs executed by the plurality of virtual machines;
generating an update request message for requesting one or more virtual machines including the plurality of update-target routing tables to update the plurality of update-target routing tables, the one or more virtual machines being included in the plurality of virtual machines; and
transmitting the update request message to the one or more virtual machines,
wherein, in the generating and the transmitting of the update request message, the update request message is generated and transmitted to update a second update-target routing table after a first update-target routing table is updated among the plurality of update-target routing tables, the second update-target routing table having a priority lower than a priority of the first update-target routing table.
